(19) United States
(12) Patent Application Publication
(10) Pub. No.: US 2021/0065113 A1
(43) Pub. Date: Mar. 4, 2021

(54) Secure, Private Market Share Augmentation with Simultaneous Operational Efficiency Improvements for Delivery Providers on a Network

(71) Applicant: International Business Machines Corporation, Armonk, NY (US)

(72) Inventor: Laura WYNTER, Singapore (SG)

(21) Appl. No.: 16/557,122

(22) Filed: Aug. 30, 2019

(51) Int. Cl. G06Q 10/08; H04L 9/06; G06F 16/901; G01C 21/34

(52) U.S. Cl. CPC G06Q 10/08355; H04L 9/0637; G01C 21/3446; H04L 9/0643; G06F 16/9024

(57) ABSTRACT

A computer system accesses encrypted graph information corresponding to multiple delivery providers and comprising vehicle routes for the delivery providers and forms a complete graph based thereon. The computer system performs an identification of a bottleneck in the complete graph and sends message(s) to any delivery providers affected by the identified bottleneck to alert the affected delivery providers of the identified bottleneck. In another example, the computer system performs, using the complete graph, an identification of possible market share augmentation for the delivery provider(s). The computer system sends message(s) to the delivery provider(s) to alert the delivery provider(s) of the identified possible market share augmentation. As further examples, a given delivery provider can send message(s) to its vehicle(s) to alert the vehicles about the bottleneck or perform market share augmentation.

### BACKGROUND

This invention relates generally to delivery of items and, more specifically, relates to secure, private market share augmentation with simultaneous operational efficiency improvements for delivery companies on a network.

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section.

The market for delivery of items is growing significantly, expanding beyond the classic parcel delivery companies (such as DHL and FedEx) to home delivery of groceries (Redmart, Amazon Prime, FreshDirect), restaurant take-out food (Grab Food, UberEats, and the like), laundry services (HonestBee), as well as new players in traditional parcel delivery (GogoVan, EasyParcel, and the like). GogoVan allows people to hire a van, and EasyParcel is a logistics service platform that allows people to check for delivery rate from different courier companies and book for delivery online.

Many of these companies are emerging due to the peer-to-peer revolution started by Uber (a service for hiring an on-demand private driver) and AirBnB (a service for renting accommodations from private owners). While some of the above companies use dedicated delivery staff and vehicles, others use part time staff on their own vehicles.

This emergence of many new players has opened up possibilities for cross-company optimization and machine learning, potentially of benefit to all parties. However, due to the highly competitive nature of the industry, traditional methods for sharing data and insights would not be welcomed.

### SUMMARY

This section is meant to be exemplary and not meant to be limiting.

In an exemplary embodiment, a method comprises accessing by a computer system encrypted graph information corresponding to multiple delivery providers and comprising vehicle routes for the delivery providers. The method includes forming by the computer system a complete graph based on the encrypted graph information, and performing by the computer system an identification of a bottleneck in the complete graph. The method includes sending by the computer system one or more messages to any delivery providers affected by the identified bottleneck to alert the affected delivery providers of the identified bottleneck. An apparatus could comprise one or more memories having computer-readable code thereon and one or more processors. The one or more processors, in response to retrieval and execution of the computer-readable code, could cause the apparatus to perform the operations of the method in this paragraph. In another exemplary embodiment, a computer program product comprises a computer readable storage medium having program instructions embodied therewith. The program instructions are executable by a computer system to cause the device to perform the operations of the method in this paragraph.

In a further exemplary embodiment, a method includes sending, by a computer system to another computer system over a network, graph information corresponding to a delivery provider and comprising vehicle routes for the delivery provider. The graph information is either encrypted by the computer system prior to the sending or will be encrypted by the other computer system. The method includes receiving, by the computer system and from the other computer system, one or more messages indicating the delivery provider is affected by an identified bottleneck. The method includes sending by the computer system one or more messages to alert one or more vehicles whose routes are affected by the identified bottleneck. The one or more vehicles are controlled by the delivery provider. An apparatus could comprise one or more memories having computer-readable code thereon and one or more processors. The one or more processors, in response to retrieval and execution of the computer-readable code, could cause the apparatus to perform the operations of the method in this paragraph. In another exemplary embodiment, a computer program product comprises a computer readable storage medium having program instructions embodied therewith. The program instructions are executable by a computer system to cause the device to perform the operations of the method in this paragraph.

In a further exemplary embodiment, a method includes accessing by a computer system encrypted graph information corresponding to multiple delivery providers and comprising routes taken by or to be taken by vehicles for the delivery providers. The method includes forming by the computer system a complete graph based on the encrypted graph information, and performing, using the complete graph and by the computer system, an identification of possible market share augmentation for one or more of the delivery providers. The method includes sending one or more messages to the one or more delivery providers to alert the one or more delivery providers of the identified possible market share augmentation. An apparatus could comprise one or more memories having computer-readable code thereon and one or more processors. The one or more processors, in response to retrieval and execution of the computer-readable code, could cause the apparatus to perform the operations of the method in this paragraph. In another exemplary embodiment, a computer program product comprises a computer readable storage medium having program instructions embodied therewith. The program instructions are executable by a computer system to cause the device to perform the operations of the method in this paragraph.

### BRIEF DESCRIPTION OF THE SEVERAL VIEWS OF THE DRAWINGS

FIG. 1 is an illustration of improvement in operational efficiency using exemplary techniques presented herein;

FIG. 2 is a flowchart of a method performed by a computer system, such as a server or block chain node, for secure operational efficiency improvements for delivery providers on a network, in accordance with an exemplary embodiment;

FIG. 3A is an illustration of a graph and corresponding operations performed by a server and multiple delivery providers for a (e.g., centralized) server example, in an exemplary embodiment;

FIG. 3B is an illustration of a graph and corresponding operations performed by a blockchain and multiple delivery providers for a distributed blockchain (BC) example, in an exemplary embodiment

FIG. 3C is an illustration of a graph and corresponding operations performed by a blockchain and multiple delivery providers for a cloud blockchain (BC) example, in an exemplary embodiment;

FIG. 4 is a flowchart of a method performed by a computer system, such as a server or block chain node, for secure market share augmentation with simultaneous operational efficiency improvements for delivery providers on a network, in accordance with an exemplary embodiment;

FIG. 5 is an illustration of a graph and corresponding operations performed by multiple delivery providers in an exemplary embodiment; and

FIG. 6 is a block diagram having an illustration of an exemplary system and corresponding computer system in an exemplary embodiment.

### DETAILED DESCRIPTION

The following abbreviations that may be found in the specification and/or the drawing figures are defined as follows:

2HCLI 2-hop cover labeling index

BC blockchain

DP delivery provider

ID identification

MPC multi-party communication

SMC secure multi-party computation

SWHE somewhat homomorphic encryption

TEE trusted execution environment

The table below lists notations that are used in the text and/or figures, and also the meaning of that notation.

| Notation | Meaning |
|---|---|
| j(i) | set of data for each delivery provider, j, for |
| | each delivery route, i |
| o | origin vertex |
| d | destination vertex |
| a | constraint |
| D(P) | shortest distance of path, P |
| C(P) | Generic constraint function (could be time |
| | taken or any other constraint on path P and a |
| | is the limit on that value), C(P) < a |
| P | path |
| j | delivery provider |
| j(i) | vector of delivery providers |
| i | delivery route |
| G(j(i)) | graph of the set of data for each delivery |
| | provider, j, for each delivery route, i; |
| | G(j(i)) = [k₁, t₁; k₂, t₂; . . . kₙ, tₙ] |
| v | product |
| kᵢ | kᵢ = (cᵢ, xᵢ, yᵢ, Δtᵢ, vᵢ), a client tuple |
| t | arrival time |
| c | client ID |
| x | location |
| y | location |
| x, y | client location in x, y location coordinates |
| Δtᵢ | change in time (e.g., from route change) for |
| | client i |
| vᵢ | vector of products delivered to client i |
| w | feasible time window, e.g., (earliest, latest) |

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

As previously described, there has been an emergence of many new players in delivery services, which has opened up possibilities for cross-company optimization and machine learning, potentially of benefit to all parties. However, due to the highly competitive nature of the industry, traditional methods for sharing data and insights would not be welcomed. New approaches are disclosed herein that may be used to create new business and/or improve overall efficiency in this sector.

Improvements using the exemplary embodiments can be divided into operational efficiency and market share augmentation. Operational efficiency concerns the efficiency of each delivery provider and the efficiency of the group of providers as a whole. Market share augmentation involves one delivery provider improving its market share based on information from one or more other providers (or other companies, or the like).

Regarding operational efficiency, operational efficiency suffers when delivery is attempted at a client location but is infeasible, possibly due to lack of parking at the location, or missing the time window due to unforeseen congestion or other obstacles. As each delivery provider consolidates their deliveries to each location during acceptable time windows, the delivery provider does not receive data from their delivery staff that can be leveraged to improve the operational efficiency of the other delivery staff, except on a long-term trend basis. However, other delivery providers have real-time information from their delivery staff as to, for instance, the status of the available parking and reachability of the destination under current conditions. Optimizing the parking and the routing for each delivery provider as a function of all other delivery providers allows for significantly enhanced operational efficiency for all. However, the client delivery data is highly confidential to each company. As such, the methods proposed below ensure no leakage of confidential data to competitors.

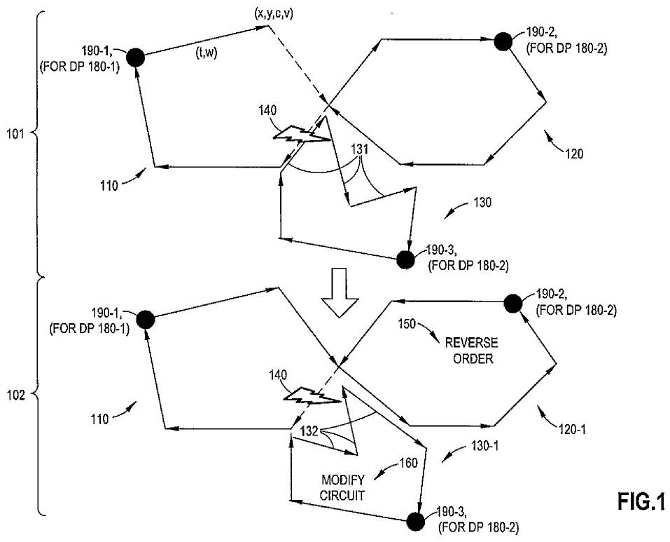

Turning to FIG. 1, this figure is an illustration of improvement in operational efficiency using exemplary techniques presented herein. The top part 101 of the figure illustrates what might happen in a typical scenario not using the techniques described herein. There are three delivery vehicles, 190-1, 190-2, and 190-2, each corresponding to a respective delivery provider (DP) 180-1, 180-2, and 180-3. A delivery provider 180 is any entity that makes deliveries of any product or service to geographical locations. Such providers may also be referred to as companies herein. The variables are described in the table above but represent the following: t=arrival time, w=feasible time window (earliest, latest); c=client ID, x,y=client location, v=products delivered.

Each route 110, 120, 130 is a route of deliveries by a different delivery provider 180. For instance, DHL (a package delivery company) may be a delivery provider 180-1, FedEx (Federal Express, another package delivery company) may be delivery provider 180-2, and UberEats (a food delivery service, delivering food from local restaurants) could be delivery provider 180-3. These providers 180 do not share information, but their routes 110, 120, 130, respectively, share the infrastructure (roads, clients, parking, and the like). A part of the route 130 is illustrated by reference 131, and this is the originally planned delivery route. The lightning bolt 140 signifies a perturbation that prevents that link from being used. This perturbation was observed by the (e.g., driver of) the vehicle 190-1, and therefore by DHL 180-1, who suffered likely delays as a result. Similarly, the vehicle 190-3 for UberEats 180-3 would also suffer similar delays.

However, the providers 180 may have real-time information from their delivery staff as to the status of the available parking and reachability of the destination under current conditions. Optimizing the parking and the routing for each delivery company 180 as a function of all other delivery companies 180 allows for significantly enhanced operational efficiency for all. In fact, (secure) information sharing would allow DHL 180-1 and UberEats 180-3 to perform real-time re-routing to avoid the problem at the lightning bolt 140.

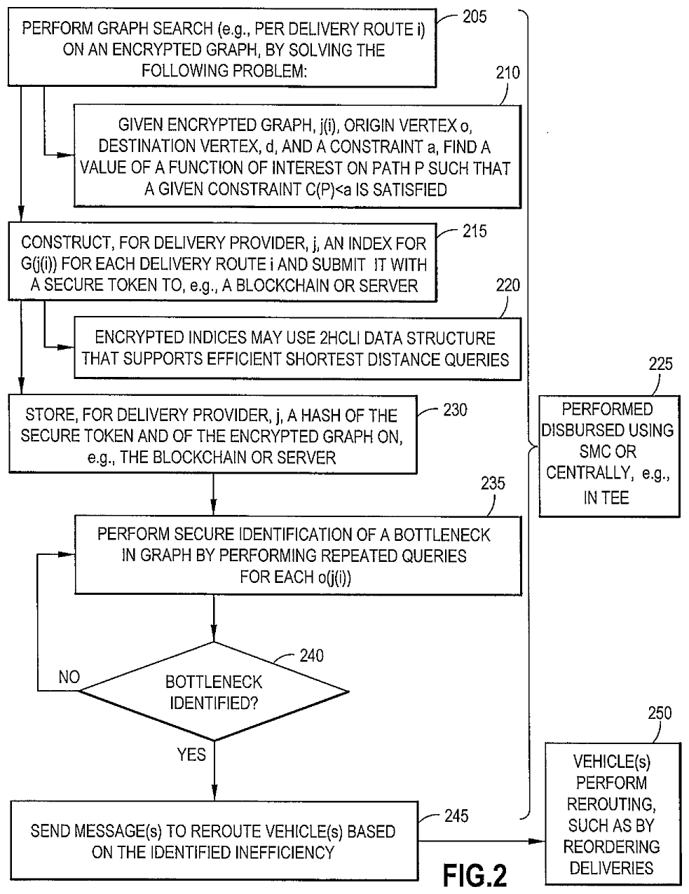

This is illustrated by the bottom part 102 of FIG. 2, which illustrates what might happen in this scenario by using the techniques described herein. The delivery provider 180-3, UberEats, is able to modify its route taken by its vehicle 190-3 in reference 160 to avoid the problem at the lightning bolt 140. This creates a revised route 130-1, where reference 132 indicates a change to the route to avoid the perturbation at the lightning bolt 140. Additionally, the delivery provider 180-2, FedEx, may reverse the order of the route taken by its vehicle 190-2, e.g., in order to avoid additional traffic near intersections around where the lightning bold 140 occurred, and this creates the revised route 120-1.

Regarding market share augmentation, market share and customer data is one of the most valuable by-products of many companies' operations. These data are often leveraged for cross-sell or upsell as well as re-selling data or insights from them to other companies, e.g., from advertisement companies to other types of goods or services. A solution to the operational efficiency problem described with respect to FIG. 1 (described previously) has the potential to become more valuable to the participating delivery companies as well as to the platform provider. With each delivery is information about the client such as the following: location, date and time of purchase, and hence the frequency of deliveries to that client. In addition, each delivery provider may also possess information on the purchased items themselves. It is noted that having information about the items themselves is just an example. In the case of DHL/FedEx (or other package delivery companies), knowing the destination customer, the origin sender, package size and/or frequency of deliveries would be sample information useful for the competitors. By combining information across delivery companies, a highly-valuable customer profile can be provided to each participating company, or potentially to third parties. However, as before with operational efficiency, customer purchase data is highly confidential to each company. As such, the methods proposed herein ensure no leakage of confidential data to competitors.

In order to implement improvements in market share augmentation while maintaining privacy, in an exemplary embodiment, private aggregation by key is performed such that keys include client ID, client location, delivery provider, and also all products purchased for each key value are determined. Additionally, for private set functions, which may be queried by any delivery provider 180, these might include the following: 1) a set of delivery providers used by each client, and the complement of the set (e.g., indicating which delivery providers are not used by each client); 2) a set of products purchased by each client from each delivery provider (e.g., as well as other data regarding the customer's relationship with each of the providers), and complement of this set over other delivery providers (e.g., indicating which products are not purchased from each delivery provider); and/or 3) a set of products purchased by all clients in a neighborhood of each client, and a complement of the set over other clients. That is, for market share augmentation, the products delivered to a client by company A is valuable information for company B, allowing company B to offer up-sell/cross-sell opportunities to the client. A delivery provider 180 might query using these functions and determine whether clients from certain locations could be sold other products. For example, a restaurant delivery service could determine their market share might be improved by advertising in a certain neighborhood. Similarly, a package delivery company wanting to increase market share in certain residential or commercial neighborhoods, which are frequent customers of a competitor delivery company, may choose to offer new customer discounts in such neighborhoods. The products delivered are less relevant for operational efficiency.

Regarding private, secure function evaluation, e.g., for market share augmentation as it concerns information on the products delivered, security of evaluations assumes a minimum number (n) of delivery companies. For instance, n>3, if similar products, larger if different product types are sold. Security here means privacy of the information. If the content being protected is of the same type, then having three companies is enough to not know from which company the product originated. If the products are different, then having the product information is enough to identify the company if n is not large enough. As an illustration, if DHL delivers parcels and UberEats delivers food, then knowing that client i is receiving food, this identifies that the client is an UberEats client. This therefore reduces privacy, and illustrates the desire to have a minimum number of companies. It is noted that this assumes that there is no confidentiality pertaining to the routes themselves.

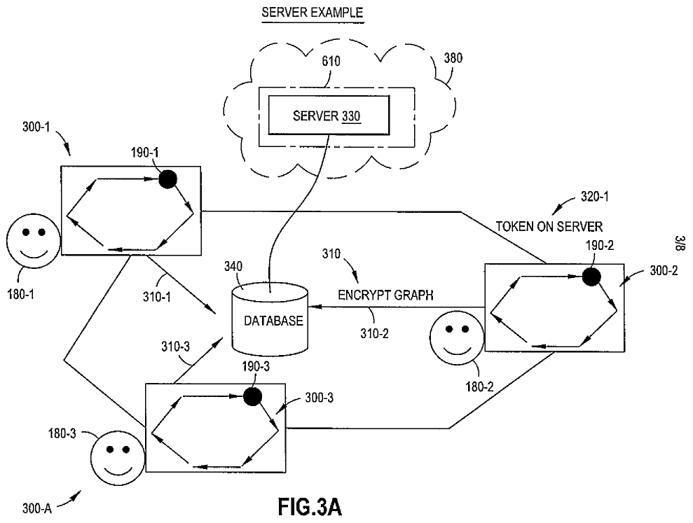

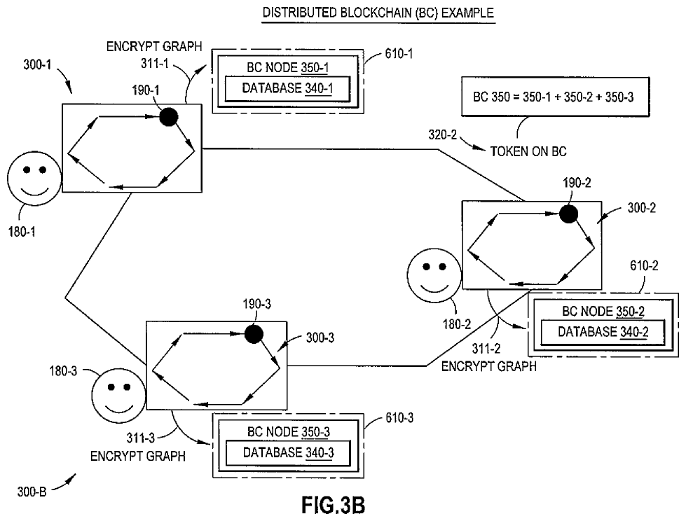

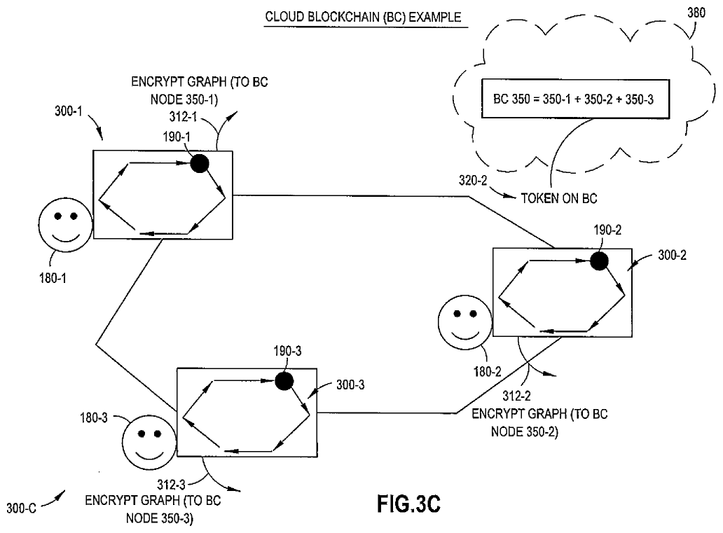

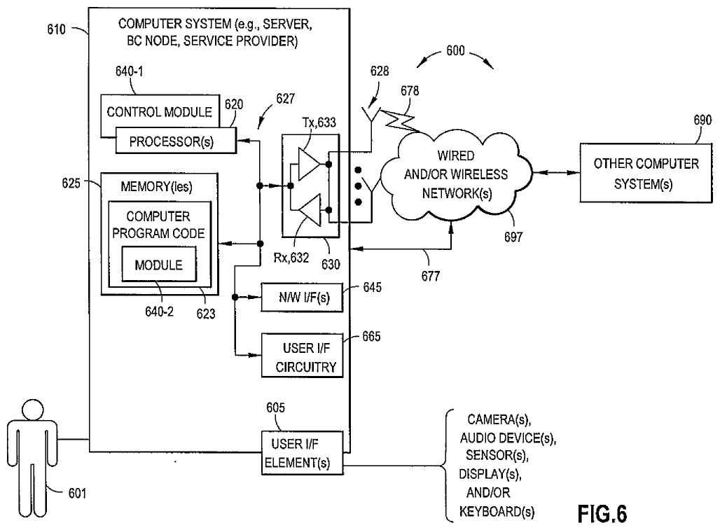

FIG. 2 is a flowchart of a method performed by a computer system, such as a server or block chain node, for secure operational efficiency improvements for delivery providers on a network, in accordance with an exemplary embodiment. This illustrates secure and private graph querying for route re-ordering. It is noted that cryptographic protocols may be used for the blocks in the following figures, including an ability to generate key pairs, encrypt graphs and data set vectors, decrypt, generate proofs, and validate. An exemplary embodiment with a server is described more detail in FIG. 3A, and exemplary embodiments with blockchain nodes and corresponding blockchains are described in more detail in FIGS. 3B and 3C. An exemplary computer system for these implementations is described in FIG. 6.

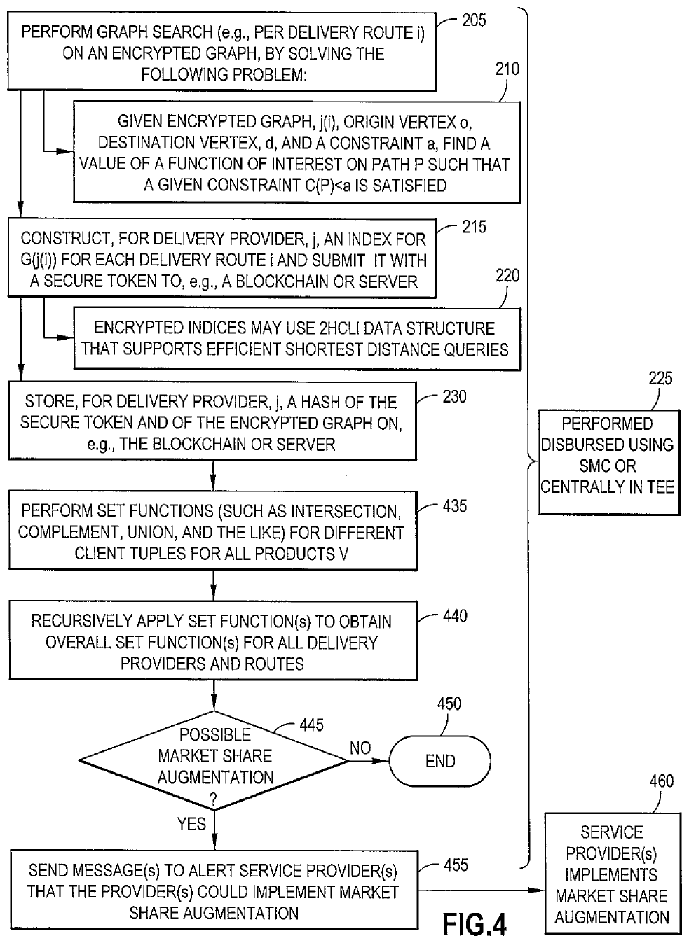

FIG. 2 (and also FIG. 4) considers the case where there is a server 330 (see FIG. 3A) or blockchain (BC) 350 (see FIGS. 3B and 3C) that performs most of the operations in FIG. 2. Additionally, the delivery providers 180 and their operations are considered. Often, these operations are considered to be “mirror images” of each other. For instance, if a delivery provider 180 submits an index, a server 330 (see FIG. 3A) or blockchain (BC) 350 (see FIG. 3B or 3C) effectively receives that index. Furthermore, one can think of the operations of reading and writing as different. When the delivery provider 180 performs a graph search on the encrypted graph (e.g., on the central server and in response to a request from the delivery provider), the delivery provider 180 does not need to submit a token. When, however, the delivery provider 180 wants to submit something (e.g., writes to the, e.g., central server), then the delivery provider 180 performs the submission with a token, to manage the access by the other delivery providers 180. That is, having the token is like having a key to a lock. So the delivery provider 180 (e.g., provider 1) “locked” the information and only those providers with the correct “key” (e.g., token) can “unlock” the information and read or use the information. For ease of reference, FIG. 2 (and also FIG. 4) is explained using a server, as this makes the explanation easier to understand. The concepts are similar for the BC example, except that the operations are more distributed in application.

As illustrated by block 225, blocks 205 through 245 may be performed disbursed (e.g., decentrally) using SMC or centrally, such as in a Trusted Execution Environment (TEE). Any method (e.g., blockchain, Trusted Execution Environment, TEE) may be used for secure storing of encrypted data such as a hash, user tokens, encrypted graphs, and the like. It is also noted that the operations shown are representations of the types of operations that can be performed, but the operations are not limited to these. For instance, blocks 204 and 210 are examples of graph searches (such as for a shortest path) that can be performed on encrypted data, but are not exhaustive in their disclosure and other searches may be performed.

In block 205, the server performs graph search (e.g., per delivery route i) on an encrypted graph, by solving the following problem (see block 210): Given encrypted graph j(i), origin vertex o, destination vertex d, and a constraint a, find a value of a function of interest on path P, such as the shortest distance D(P) or other function, such that a given constraint C(P)<a is satisfied. C(P) is a generic constraint function (could be time taken or any other constraint on path P and a is the limit on that value), C(P)<a. This block does not present all the examples of what kind of constraint functions or functions of interest would be used, but these are merely some possible examples. Block 210 may use protocols for performing constrained shortest path on the encrypted graph using (e.g., SomeWhat Homomorphic Encryption, SWHE, evaluation) private summation and filtering. Note also that the server may perform any required encryption (and corresponding protocols), e.g., so that each delivery provider 180 is guaranteed privacy for his or her own data. Note also that a delivery provider 180 could request the server to perform blocks 205 and 210, e.g., via a request including, e.g., the origin vertex o, destination vertex d, the constraint a, and an indication of a function of interest on path P. Furthermore, depending on implementation, each delivery provider 180 may encrypt any of its own information, including information about its (sub)graph 300-x (where x is 1, 2, or 3 in the examples).

In block 215, the delivery provider 180, j, constructs an encrypted index for G(j(i)) for each delivery route i and submits the encrypted index with a secure token. This submission will be to the (e.g., cloud) server (e.g., or to a blockchain as in FIG. 3B), which receives the submission (e.g., and incorporates the submission into the encrypted graph). Encrypted indices, in an exemplary embodiment, see block 220, use a 2HCLI data structure that supports efficient shortest distance queries. 2HCLI is a secure 2-hopcover labeling index, which is a type of distance oracle such that the approximate distance between any two vertices in a graph can be efficiently computed. See, e.g., Meng Shen, Baoli Ma, Liehuang Zhu, Rashid Mijumbi, Xiaojiang Du, and Jiankun Hu. “Cloud-based approximate constrained shortest distance queries over encrypted graphs with privacy protection”, IEEE Transactions on Information Forensics and Security 13, no. 4 (2018): 940-953.

In block 230, the server stores a hash of the secure token and of the encrypted graph in a suitable database on the server. As is known, the hash is a secure way to store the token. Alternatively, the blockchain stores the hash of the secure token and of the encrypted graph. To use this, one gets the hash and the secure token, which will need to be decrypted. In block 235, the server performs secure identification of a bottleneck in the graph by performing repeated queries for each o(j(i)), which is an origin vertex (o) for each delivery provider (j) for each route (i). Identifications of a bottleneck include that the shortest distance path will have changed from what the shortest distance path previously was (e.g., the shortest path will no longer contain the link with the lightning bolt 140 in FIG. 1). Note that block 235 may be requested by individual ones of the delivery providers 180. In other words, the server (or a blockchain) may automatically perform block 235, e.g., periodically, or a delivery provider 180 would request block 235 be performed by the server, or some combination of these. A bottleneck is any inefficiency in the graph that could cause a delay, such as lack of parking, car accident, road work, and the like. If a bottleneck is not identified (block 240=No), the flow proceeds to block 235 again, e.g., perhaps after some delay.

Meanwhile, if a bottleneck is identified (block 240=Yes), the flow proceeds to block 245, where the server sends message(s) to reroute vehicle(s) based on the identified inefficiency. This sending is performed securely, e.g., using one or more secure protocols. In an exemplary embodiment, when SMC is used, a blockchain node may be used at a corresponding delivery provider 180, and the blockchain node would send the messages, and thus would be sent by the delivery provider 180. In the alternative embodiment mainly used with respect to FIG. 2, when a server is used as the computer system performing the operations, the message(s) are sent by the server to a delivery provider 180, which then also sends message(s) to any vehicles that are affected. In block 250, the vehicle(s) perform rerouting, such as by reordering deliveries, e.g., as illustrated in FIG. 1.

It is noted that each delivery provider 180 could be independently performing the blocks in FIG. 2, if SMC is used. Alternatively, a server using a TEE could perform the blocks in FIG. 2 (except for block 250, which is performed by the delivery provider 180). The same is true for the actions in FIGS. 3A-3C, described now.

Referring to FIG. 3A, this figure is an illustration of a graph 300-A and corresponding operations performed by a server and multiple delivery providers for a (e.g., centralized) server example, in an exemplary embodiment. The graph G(j(i))=[k₁,t₁; k₂,t₂; . . . ; kₙ,tₙ], where the client tuple kᵢ=(cᵢ, xᵢ, yᵢ, Δtᵢ, ±vᵢ), c is a client ID, x and y are client locations, Δtᵢ is the change in time (e.g., from route change) for client i, and vᵢ is a vector of products delivered to client i. It is noted that an entire graph G 300-A includes (sub)graphs 300-1, 300-2, and 300-3 from each respective one of delivery providers 180-1, 180-2, and 180-3 and also shows their respective delivery vehicles 190-1, 190-2, and 190-3. FIG. 3A is a simple illustration of this graph 300-A and each delivery provider 180-1, 180-2, and 180-3 is shown encrypting (see respective references 310-1, 310-2 and 310-3) its own respective graph 300-1, 300-2, 300-3 (e.g., based on respective routes 110, 120, 130 from FIG. 1) and loading this into a database 340 in a server 330 (implemented by a computer system 610, see FIG. 6). Each delivery provider 180 would also load a token (as described above) to the server 330, although only the delivery provider 180-2 is shown performing this as illustrated by reference 320-1. With the token, a delivery provider 180 can get authorized information from the other providers.

A server 330 would use techniques such as the TEE in order to provide security of the information stored on the server and communicated to or from the server. One option for the server 330 is to be located on the cloud 380, although other options are possible.

Turning to FIG. 3B, this figure is an illustration of a graph and corresponding operations performed by a blockchain and multiple delivery providers for a distributed blockchain (BC) example, in an exemplary embodiment. As is known, a blockchain is an incorruptible digital ledger of transactions that can be programmed to record not just financial transactions but virtually everything of value. The blockchain is distributed using individual computer systems, and this system could use SMC or a similar protocol to perform distributed calculations and other operations.

In this example, the blockchain (BC) 350 comprises three blockchain nodes 350-1, 350-2, and 350-3, each one at a respective delivery provider 180-1, 180-2, 180-3. Each BC node 350-1, 350-2, and 350-3 is implemented by a corresponding computer system 610-1, 610-2, or 610-3. Each BC node 350-1, 350-2, and 350-3 has its own copy of a database 340-1, 340-2, and 340-3, which should be the same even though they are independently created. Each BC node 350-1, 350-2, and 350-3 would create the entire graph 300-B. Each delivery provider 180-1, 180-2, and 180-3 is shown encrypting (see respective ones of references 311-1, 311-2, and 311-3) its own respective graph 300-1, 300-2, 300-3 (e.g., based on respective routes 110, 120, 130 from FIG. 1) and loading this into a respective database 340-1, 340-2 and 340-3. The BC nodes 350-1, 350-2, and 350-3 would communicate, using SMC or other similar protocol, to send, e.g., via a round-robin technique, their portion 300-1, 300-2, or 300-3 to the other BC nodes. Each BC node 350-1, 250-2, and 350-3 then has all the information necessary to create the graph 300-B and to perform the operations in FIG. 2 (and also FIG. 4).

The BC 350 in FIG. 3B is illustrated in a distributed example. Classically, the blockchain would be stored locally on the peer nodes which are connected, as in FIG. 3B. For instance, FIG. 3B illustrates a representation of how a blockchain 330 might be implemented, e.g., in computers 610-1, 610-2, and 610-3 (e.g., as peer nodes) for each of the corresponding delivery providers 180-1, 180-2, and 180-3. The graphs 330 are also stored as replicas on the peer nodes 610-1, 610-2, 610-3 of all the participants (e.g., delivery providers 180), as in a classical blockchain.

However, the blockchain 350 may also be on the cloud 380, as illustrated in FIG. 3C and its corresponding graph 300-C. That is, having the blockchain 350 be in the cloud 380 also works. In this example, the BC nodes 350-1, 350-1, and 350-3 are in the cloud 380 and each is accessible by a corresponding delivery provider 180-1, 180-2, or 180-3, e.g., by appropriate network(s) and protocol(s). Each delivery provider 180-1, 180-2, and 180-3 is shown encrypting (see respective ones of references 312-1, 312-2, and 312-3) its own respective graph 300-1, 300-2, 300-3 (e.g., based on respective routes 110, 120, 130 from FIG. 1) and loading this into a respective database 340-1, 340-2 and 340-3 (each of the respective BC nodes 350-1, 350-2 and 350-3 has a database as in FIG. 3B). The graphs 330 may still be stored as replicas on the peer nodes 610-1, 610-2, 610-3 (see also FIG. 3B) and corresponding databases 340-1, 340-2, and 340-3 of all the participants (e.g., delivery providers 180-1, 180-2, 180-3), as in a classical blockchain.

Regardless of implementation, in an exemplary embodiment, each delivery provider 180 independently creates its own part of a graph, and then these are all “spliced” together to create a single large graph. The lat-long (latitude-longitude) identifies the exact location of a vertex. Similarly, e.g., in Singapore where postal codes refer to a building, that can be used. Also, a geo-hash can be used to precisely locate places. This allows the blockchain 350/server 330 to create the overall graph 300.

Decryption is available via the tokens for authorized participants and the authorized functions. Encrypted equality of two values can be performed under homomorphic encryption protocol, so that someone with the token could obtain the result of the equality comparison of the location values.

FIGS. 2 and 3A-3C are directed to operational efficiency improvements by themselves. With the graph framework, however, other beneficial analyses can be performed, such as for market share augmentation. As described above, with respect to private, secure function evaluation for market share augmentation, security of evaluations assumes a minimum number (n) of delivery companies such that n>3, if similar products, and a larger number if different product types are sold. As also previously described, this is because, if the content being protected is of the same type, then having three companies is enough to not know from which company the product originated. Meanwhile, if the products are different, then having the product information may be enough to identify the company if n is not large enough.

Secure and private aggregation and set functions for market enhancements are now described. The set of market share enhancements relies on private set intersection. Recall that the set of data is encoded for each delivery provider, j, for each delivery route, i, as G(j(i)). Each G(j(i)) is encrypted as ciphertext, and may be used along with a private and public key and a secret token. The set intersection is performed on the ciphertexts. The result is returned to the delivery provider with a proof of its correctness. The delivery provider validates the proof using the secret token.

Turning to FIG. 4, this figure is a flowchart of a method performed by a computer system, such as a server or block chain node, for secure market share augmentation with simultaneous operational efficiency improvements for delivery providers on a network, in accordance with an exemplary embodiment. Blocks 205-230 have been described with respect to FIG. 2, so will not be described here. These computations can be performed on a central server if that is the way in which the implementation is performed. If the implementation is on a peer-to-peer blockchain, then the supplementary analytical functions that perform this task can be done on the peer nodes, in this case those of the delivery providers. Both implementations as noted above are possible. As with FIG. 2, FIG. 4 is described as being performed by a server 330, but may also be performed by a blockchain 350.

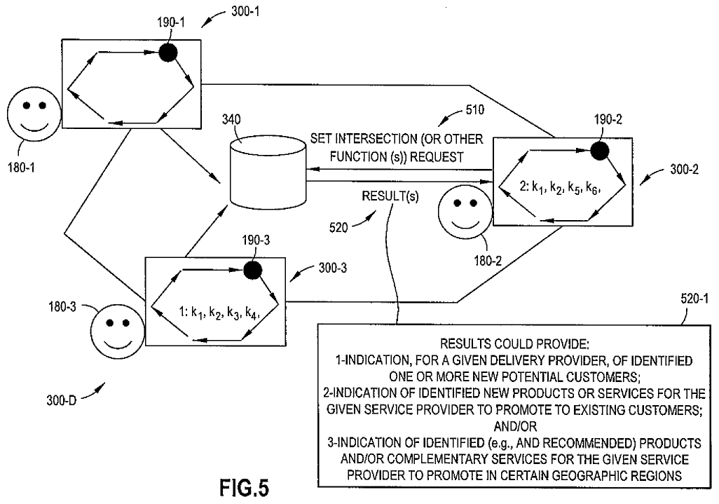

In block 435, the server 330 performs set functions (such as intersection, complement, union, and the like) for different client tuples for all products v. This may also be requested (e.g., see reference 510 of FIG. 5) by a delivery provider 180, so that the service provider 330 performs block 435 in response to the request. In more detail, recall that graph G(j(i))=[k₁,t₁; k₂,t₂; . . . ; kₙ,tₙ], where the client tuple kᵢ=(cᵢ, xᵢ, yᵢ, Δtᵢ, ±vᵢ), c is a client ID, x and y are client locations, Δtᵢ is the change in time (e.g., from route change) for client i, and vᵢ is a vector of products delivered to client i. Regarding the Δtᵢ, the time on the delivery route may have changed due to a perturbation. The rest of the client tuple will be unchanged, but there may be a new travel time. If there is no new travel time, then Δtᵢ,=0, otherwise it may be >0. For this example, see also FIG. 5, which illustrates a graph 300-D that is similar to the graph 300-A of FIG. 3A, and also illustrates corresponding operations performed by multiple delivery providers 180-1 through 180-3 in an exemplary embodiment. The graph 300-3 has a set 1 of client tuples {k₁, k₂, k₃, k₄}, and the graph 300-2 has a set 2 of client tuples {k₁, k₂, k₅, k₆}. Then, for example, the following may be used:

S(1,2)=SetIntersect(j(i)¹,j(i)²)=k₁, k₂;

\S(1,2)=>S^{u}:=SetUnion (j(i)¹, (j(i)²;

\SetIntersect(j(i)¹,j(i)²)=SetUnion(SetIntersect (S^{u}, j(i)¹), SetIntersect(S^{u},(j(i)²)))=k₃, k₄, k₅, k₆.

The “\” indicates complement, the underlining indicates the element is a vector, e.g., j(i) is a vector of delivery providers, and S(1,2) is the intersection between sets 1 and 2.

And using S(1,2), the definition is applied to products v in block 435. Similarly, the definition is recursively applied to obtain the overall set intersections for delivery providers and routes 1, . . . n. See block 440, where the set function(s) are recursively applied by the server 330 to obtain, e.g., overall set intersections for all delivery providers and routes. Similarly, this may be performed for the complements and unions. Blocks 435 and 440 may use protocols for performing, e.g., private set function (e.g., intersection) operations (e.g., SWHE, or MPC). In FIG. 5, reference 510 indicates the delivery provider 180-2 sending a set intersection (or other function(s)) request, and a result (or results) being provided (reference 520) back to the delivery provider 180-2.

In block 445 of FIG. 4, the delivery provider 180 determines whether there is a possible market share augmentation that is indicated by the result(s). In general and simplistic terms, this is looking for differences in the sets. For instance, for FIG. 5, the delivery provider 180-3, which has set k1, k2, k3, and k4, is interested that k3 and k4 are not in the graph by delivery provider 180-2. If a possible market share augmentation is not indicated (block 445=No), the method ends in block 450. If a possible market share augmentation is indicated (block 445=Yes), the delivery provider 180 in block 455 sends one or more messages to a service provider to alert the provider implement market share augmentation, e.g., in specific areas. This sending is performed securely, e.g., using one or more secure protocols. This alert would be used by other departments in the service provider's company (e.g., to use to deploy new advertisements in a neighborhood). The set operations provide information such that a service provider can offer data to other companies that the provider does not have already (e.g., new potential customers, new products to propose to their existing customers, and the like). In block 460, the operator(s) implement the market share augmentation. The various strategies would involve location-specific advertising and personalized advertising. These may include information about products and services or may include discounts or reward points, and the like.

As more specific examples, the performance of the set functions in block 435 and the recursive application of the set functions in block 440 could provide one or more of the following for a given delivery provider: identified one or more new potential customers; identified new products or services for the given service provider to promote to existing customers; identified (e.g., and recommended) products and/or complementary services for the given service provider to promote in certain geographic regions. As part of block 455, and as indicated in block 520-1 as results 520, the results 520 could provide one or more of the following:

1—Indication, for a given delivery provider, of identified one or more new potential customers;

2—Indication of identified new products or services for the given service provider to promote to existing customers; or

3—Indication of identified (e.g., and recommended) products and/or complementary services for the given service provider to promote in certain geographic regions.

For instance, the set operations performed by the set functions in blocks 435 and 440 could determine, for a given delivery provider 180, that there are other customers for other delivery providers 180, and therefore the server (or BC) would send (1) indicated above. Similarly, the set operations performed by the set functions in blocks 435 and 440 could determine, for a given delivery provider 180, that there are other products or services provided by other delivery providers 180, and therefore the server (or BC) would send (2) indicated above. Finally, the set operations performed by the set functions in blocks 435 and 440 could determine, for a given delivery provider 180, that there are other products and/or complementary services that are provided by other delivery providers 180 within certain geographical regions (e.g., determined using a complete graph 300-D and corresponding location information), and therefore the server (or BC) would send (3) indicated above.

Turning to FIG. 6, this figure shows a block diagram of one possible and non-limiting exemplary system 600 in which the exemplary embodiments may be practiced. The computer system 610 could be used by or as the server 330, a BC node 350-x, a BC 350, a service provider 180, or the like. In FIG. 6, a computer system 610 is in wired and/or wireless communication with a wired and/or wireless network(s) 697 and through the network(s) 697 to other computer system(s) 690.

The computer system 610 includes one or more processors 620, one or more memories 625, one or more transceivers 630, one or more network (N/W) interfaces (I/F(s)) 645, and user interface circuitry 665, interconnected through one or more buses 627. Each of the one or more transceivers 630 includes a receiver, Rx, 632 and a transmitter, Tx, 633. The one or more buses 627 may be address, data, and/or control buses, and may include any interconnection mechanism, such as a series of lines on a motherboard or integrated circuit, fiber optics or other optical communication equipment, and the like. The one or more transceivers 630 are connected to one or more antennas 628. The one or more memories 725 include computer program code 623.

The computer system 110 includes a control module 640, comprising one of or both parts 640-1 and/or 640-2. The control module 640 performs the operations described above that are performed by a computer system, e.g., in FIGS. 2-5. The control module 640 may be implemented in a number of ways. The control module 640 may be implemented in hardware as control module 640-1, such as being implemented as part of the one or more processors 620. The control module 640-1 may be implemented also as an integrated circuit or through other hardware such as a programmable gate array. In another example, the control module 640 may be implemented as control module 640-2, which is implemented as computer program code 623 and is executed by the one or more processors 620. For instance, the one or more memories 625 and the computer program code 623 may be configured to, with the one or more processors 620, cause the computer system 610 to perform one or more of the operations as described herein. It should also be noted that the devices shown in the computer system 610 are not limiting and additional, different, or fewer devices may be used.

The user interface circuitry 665 communicates with one or more user interface elements 605, which may be formed integral with the computer system 610 or be outside the computer system 610 but coupled to the computer system 610. The interface elements 605 include one or more of the following: one or more camera(s); one or more audio device(s) (such as microphone(s), speaker(s), and the like); one or more sensor(s) (such as GPS sensor(s), fingerprint sensor(s), orientation sensor(s), and the like); one or more displays; and/or one or more keyboards. This list is not exhaustive or limiting, and other, different, or fewer elements may be used. A user 601 (a human being in this example) may interact with the computer system 610, e.g., to cause the system 610 to take certain actions. These operations may also be caused by the computer system 610, in combination with actions by the user 601 or without actions by the user 601. The computer system 610 communicates with the other computer system(s) 690 via the one or more wired or wireless networks 697, via one or both of wired link 677 and wireless link 678.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
accessing by a computer system encrypted graph information corresponding to multiple delivery providers and comprising vehicle routes for the delivery providers;
forming by the computer system a complete graph based on the encrypted graph information;
performing by the computer system an identification of a bottleneck in the complete graph; and
sending by the computer system one or more messages to any delivery providers affected by the identified bottleneck to alert the affected delivery providers of the identified bottleneck.

2. The method of claim 1, further comprising one or more vehicles of one of the affected delivery providers performing rerouting of their individual routes based on the identified bottleneck.

3. The method of claim 1, wherein:
accessing graph information further comprises receiving from a given delivery provider an index for graph information comprising a set of data for the given delivery provider for each delivery route, i, by the given delivery provider; and
forming the complete graph further comprises forming the complete graph based in part on the provided index, wherein the provided index provides a mapping to corresponding graph information supplied by the deliver provider.

4. The method of claim 3, wherein:
accessing graph information further comprises receiving, from the given delivery provider that provided the index, a secure token corresponding to the index; and
managing by the computer system access to the set of data from the given delivery provider using the secure token.

5. The method of claim 4, wherein:
the receiving the secure token corresponding to the index further comprises receiving, by the computer system and from the given delivery provider that provided the secure token, a hash of the secure token and of the graph information corresponding to this given delivery provider; and
allowing, by the computer system, write access to the graph information by the given delivery provider in response to verifying validity of the given delivery provider's hash of the secure token.

6. The method of claim 1, further comprising:
performing by the computer system a graph search per delivery route i on the encrypted graph, by solving the following problem:
given encrypted graph, j(i), origin vertex o, destination vertex d, and a constraint a, find a value of a function of interest on a path P such that a given constraint C(P)<a is satisfied, where C(P) is a constraint function.

7. The method of claim 1, wherein the computer system is one of a server or a blockchain.

8. A method, comprising:
sending, by a computer system to another computer system over a network, graph information corresponding to a delivery provider and comprising vehicle routes for the delivery provider, wherein the graph information is either encrypted by the computer system prior to the sending or will be encrypted by the other computer system;
receiving, by the computer system and from the other computer system, one or more messages indicating the delivery provider is affected by an identified bottleneck; and
sending by the computer system one or more messages to alert one or more vehicles whose routes are affected by the identified bottleneck, the one or more vehicles controlled by the delivery provider.

9. The method of claim 8, further comprising the one or more vehicles performing rerouting of their individual routes based on the identified bottleneck.

10. The method of claim 8, wherein:
sending graph information further comprises sending for the delivery provider an index for graph information comprising a set of data for the delivery provider for each delivery route, i, by the delivery provider; and
the method further comprises performing by the computer system a subsequent read or write access to the graph information based on the index.

11. The method of claim 10, wherein:
sending graph information further comprises sending a secure token corresponding to the index; and
performing by the computer system a subsequent write access to the graph information based on the index and using the secure token.

12. The method of claim 11, further comprising:
sending by the computer system a hash of the secure token and of the graph information corresponding to the delivery provider; and
performing, by the computer system, subsequent write access to the graph information by the delivery provider using the hash of the secure token from the delivery provider.

13. The method of claim 8, further comprising:
requesting, by the computer system a graph search per delivery route i on the encrypted graph, the request comprising indications of an origin vertex o, a destination vertex d, a constraint function, and a function of interest on a path P; and
receiving a result corresponding to the request.

14. A method, comprising:
accessing by a computer system encrypted graph information corresponding to multiple delivery providers and comprising routes taken by or to be taken by vehicles for the delivery providers;
forming by the computer system a complete graph based on the encrypted graph information;
performing, using the complete graph and by the computer system, an identification of possible market share augmentation for one or more of the delivery providers; and
sending by the computer system one or more messages to the one or more delivery providers to alert the one or more delivery providers of the identified possible market share augmentation.

15. The method of claim 14, wherein performing, using the complete graph and by the computer system, an identification of possible market share augmentation for one or more of the delivery providers further comprises:
the computer system performing one or more set functions for different client tuples for one or more products; and
recursively applying by the computer system the one or more set functions to obtain overall set intersections for all delivery providers and routes.

16. The method of claim 15, wherein the one or more set functions comprise one or more of intersection, complement, or union functions.

17. The method of claim 15, wherein a client tuple kᵢ=(cᵢ, xᵢ, yᵢ, Δtᵢ, vᵢ), where c is a client identification, x and y are client locations, Δtᵢ is a change in time from a route change for client i, and vᵢ is a vector of products delivered to client i.

18. The method of claim 15, wherein the performing one or more set functions and the recursively applying the one or more set functions identifies for a given delivery provider one or more new potential customers, and the sending one or more messages further comprises sending toward the given delivery provider indication of the identified one or more new potential customers.

19. The method of claim 15, wherein the performing one or more set functions and the recursively applying the one or more set functions identifies one or more new products or services for the given delivery provider to promote to existing customers, and the sending one or more messages further comprises sending toward the given delivery provider indication of the identified one or more new products or services for the given delivery provider to promote to existing customers.

20. The method of claim 15, wherein the performing one or more set functions and the recursively applying the one or more set functions identifies products or complementary services or both products or complementary services for the given service provider to promote in certain geographic regions, and the sending one or more messages further comprises sending toward the given delivery provider indication of the identified products or complementary services or both products or complementary services for the given service provider to promote in certain geographic regions.

21. The method of claim 14, wherein the computer system is one of a server or a blockchain.
